(19) United States
(12) Patent Application Publication
(10) Pub. No.: US 2024/0211211 A1
(43) Pub. Date: Jun. 27, 2024

(54) MAC APPARATUS USING FLOATING POINT UNIT AND CONTROL METHOD THEREOF

(71) Applicant: ELECTRONICS AND TELECOMMUNICATIONS RESEARCH INSTITUTE, Daejeon (KR)

(72) Inventor: Won JEON, Daejeon (KR)

(21) Appl. No.: 18/488,124

(22) Filed: Oct. 17, 2023

(30) Foreign Application Priority Data
Dec. 27, 2022 (KR) 10-2022-0186111
Apr. 4, 2023 (KR) 10-2023-0044376

(51) Int. Cl. G06F 7/544; G06F 7/487

(52) U.S. Cl. CPC G06F 7/5443; G06F 7/4876

(57) ABSTRACT

A MAC apparatus using a floating point unit is provided. The MAC apparatus includes: a multiplier that performs a multiplication operation on floating point data; an adder that performs an addition operation between the floating point data calculated by the multiplier and floating point data accumulated in an accumulation register; the accumulation register that accumulates the floating point data calculated by the adder; and an input division controller that, when two pieces of floating point data A and B larger than a calculated data type on which the multiplier performs operation processing are input as operands, divides the two pieces of floating point data A and B into a plurality of pieces of floating point data Aa, Ab, Bc, and Bd according to a specified method and inputs the floating point data Aa, Ab, Bc, and Bd to the multiplier.

### CROSS-REFERENCE TO RELATED APPLICATIONS

This application claims priority to and the benefit of Korean Patent Application Nos. 10-2022-0186111 and 10-2023-0044376, filed on Dec. 27, 2022 and Apr. 4, 2023, respectively, the disclosure of which is incorporated herein by reference in its entirety.

### BACKGROUND

### 1. Field of the Invention

The present invention relates to a multiply accumulate (MAC) apparatus using a floating point unit and a control method thereof, and more particularly, to a MAC apparatus using a floating point unit and a control method thereof, capable of processing of a MAC operation of a data type larger than a data type implemented to be processed in hardware in the floating point unit.

### 2. Description of Related Art

In general, applications based on an artificial neural network or deep learning model perform an operation on data stored in a vector or matrix form, such as pictures, voice, and pattern data.

In particular, all data is in the form of floating point based decimals, and as a result, the operation performance for floating point matrix multiplication has a significant impact on the performance of the artificial neural network applications.

The floating point matrix multiplication is performed by performing a multiplication operation between each matrix element and then performing a multiply-accumulate (MAC) (that is, a calculator that performs high-speed multiplication accumulative operations required in artificial intelligence inference and learning processes such as base learning) operation that continues to add up and accumulate.

In the case of the MAC operation in the recent artificial neural network models, a 32-bit floating point is previously used for floating point data used in the multiplication operation during the MAC operation (e.g., a multiplication operation and an accumulative addition operation). Recently, however, operations using data types smaller than the 32-bit floating point, such as 16-bit or 8-bit, have been widely used.

Unlike the multiplication operation, during the MAC operation (e.g., a multiplication operation and an accumulative addition operation), due to the nature of the operation of accumulating the results of hundreds to thousands of multiplication operations, a data type (i.e., 32-bit floating point data type) larger than the floating point data type (i.e., 16-bit, or 8-bit floating point data type) processed in the multiplication operation is used.

Recently, unlike the existing vision processing artificial neural network, transformer-based giant artificial neural networks such as generation pre-trained transformer 3 (GPT-3) require a very large computational amount. To cope with this, an ultra-large artificial neural network accelerator that has been recently released is being developed to have high-performance operation performance for floating point data types smaller than 32-bit (e.g., TF32 (19-bit), FP16, BF16, and FP8). In particular, a transprecision floating point unit (TP-FPU) capable of performing operations on data types of various sizes within one shared FPU is also used, thereby performing parallel operations on data types smaller than 32-bit.

For reference, the FPU performs various types of operation processing, such as four arithmetic operations on floating point data, which is used to express real numbers in binary in a computer system. To support efficient parallel operations for various types of floating point data types (e.g., FP64, FP32, TF32, FP16, BF16, and FP8) (see FIG. 1), a structure that may process multiple pieces of small data in parallel using an FPU for one large data type (e.g., FP64) has been disclosed (see FIG. 2).

In FIG. 1, S represents a sign bit, E represents exponent bits, and M represents mantissa bits.

FIG. 2 illustrates an FPU structure that may simultaneously calculate two FP32 (P0, P1), four FP16 (P0 to P3), or eight FP8 (P0 to P7) data in parallel using one FP64 FPU multiplier.

The existing FPU has a very efficient structure in that it utilizes the FPU to calculate one large data type (e.g., FP64) and performs an operation on multiple smaller data types (e.g., FP32, TF32, FP16, BF16, and FP8).

However, due to the nature of hardware of the floating point unit, there is a problem in that operations on data types larger than the data type implemented to be processed in hardware in the floating point unit are impossible (i.e., it has the characteristics that operations can only be performed on data types smaller than the data type implemented to be processed in hardware in the floating point unit).

That is, since the FP64 FPU as illustrated in FIG. 2 is implemented with the FP64 as the maximum operation support size due to the nature of the hardware, there is a problem in that the operation cannot be performed on data types (i.e., FP128, etc.) larger than the size of the floating point unit implemented in hardware.

For example, like Tesla D1 and Google TPUv4 among the artificial neural network accelerators illustrated in FIG. 3, there is a problem in that operations may not be performed on data types (e.g., FP32 and FP64) larger than those implemented in hardware to perform an operation by a floating point unit that supports only 16-bit floating point data types (e.g., FP16/BF16 and FP8/INT8) dedicated to the artificial neural networks such as FP16 and FP8.

Accordingly, in order to expand versatility and supported data types of the MAC operation that may be performed without adding hardware resources of the floating point unit in the processor (or accelerator) developed for the artificial neural network acceleration, there is a need for technology that allows an operation to be performed on the floating point data type (e.g., FP32) that is larger than the floating point data type (e.g., FP16 or FP8).

The background technology of the present invention is disclosed in Korean Patent Laid-Open Publication No. 10-2022-0077076 (Jun. 8, 2022).

### SUMMARY OF THE INVENTION

The present invention provides a multiply accumulate (MAC) apparatus using a floating point unit and a control method thereof capable of processing a MAC operation of a data type larger than a data type implemented to be processed in hardware in the floating point unit.

According to an exemplary embodiment, a MAC apparatus includes: a multiplier that performs a multiplication operation on floating point data; an adder that performs an addition operation between the floating point data calculated by the multiplier and floating point data accumulated in an accumulation register; the accumulation register that accumulates the floating point data calculated by the adder; and an input division controller that, when two pieces of floating point data A and B larger than a calculated data type on which the multiplier performs operation processing are input as operands, divides the two pieces of floating point data A and B into a plurality of pieces of floating point data Aa, Ab, Bc, and Bd according to a specified method and inputs the floating point data Aa, Ab, Bc, and Bd to the multiplier.

The adder may be implemented to perform an addition operation on data at least twice as large as the floating point data type processed by the multiplier.

The accumulation register may be implemented to accumulate floating point data of the same size as the floating point data type processed by the adder.

When inputting the plurality of pieces of divided floating point data to the multiplier, the input division controller may combine the divided floating point data into four floating point data pairs according to a specified distribution law to sequentially input the corresponding floating point data pairs to the multiplier.

The input division controller may combine the floating point data into the four floating point data pairs according to the distribution law shown in Equation 1 below to sequentially input the four floating point data pairs to the multiplier and sequentially input an Aa and Bc pair, an Aa and Bd pair, an Ab and Bc pair, and an Ab and Bd pair to the multiplier.

$$A \times B = ( Aa + Ab ) \times ( Bc + Bd ) = Aa \times Bc + Aa \times Bd + Ab \times Bc + Ab \times Bd \qquad ( Equation 1 )$$

When dividing the floating point data input as the operand, the input division controller may divide a size of M so that a value divided by 2 is the same, and add 1 bit to M of any one piece of divided floating point data so that the size of the M of the divided floating point data is the same.

When 1 bit is added to the M of any one piece of divided floating point data, the input division controller may input zero (0) to a final bit value of the M of the floating point data.

The input division controller may input actual data before an operand A is divided up to a designated higher bit of the M of the divided first floating point data Aa, input zero to a final bit, input all actual data before being divided to total bits of the M of the second floating point data Ab, input the actual data before being divided up to the designated higher bit of an M of the third floating point data Bc into which an operand B is divided, input zero to the final bit, and divide the floating point data by inputting all the actual data before being divided to total bits of an M of the fourth floating point data Bd.

The input division controller may add a designated implicit bit in front of the M of the floating point data including a lower bit of the M of the floating point data before being divided to allow the multiplier to recognize floating point data including a lower-bit M value among the Ms of the operand before being divided among the divided floating point data.

The input division controller may reflect a size of the higher bit of the M changed when dividing exponent E values of second and fourth floating point data Ab and Bd including the lower bit of the M of the floating point data before being divided to adjust an exponent E′ value of the divided floating point data.

According to another exemplary embodiment, a control method of a MAC apparatus using a floating point unit that includes a multiplier that performs a multiplication operation on floating point data, an adder that performs an addition operation between the floating point data calculated by the multiplier and floating point data accumulated in an accumulation register, and an accumulation register that accumulates the floating point data calculated by the adder includes: when two pieces of floating point data A and B larger than a calculated data type on which the multiplier performs operation processing are input as operands, dividing, by an input division controller, the two pieces of floating point data A and B into a plurality of pieces of floating point data Aa, Ab, Bc, and Bd according to a specified method; and inputting, by the input division controller, the plurality of pieces of divided floating point data Aa, Ab, Bc, and Bd to the multiplier.

The adder may be implemented to perform an addition operation on data at least twice as large as the floating point data type processed by the multiplier.

The accumulation register may be implemented to accumulate floating point data of the same size as the floating point data type processed by the adder.

When inputting the plurality of pieces of divided floating point data to the multiplier, the input division controller may combine the divided floating point data into four floating point data pairs according to a specified distribution law to sequentially input the corresponding floating point data pairs to the multiplier.

When sequentially inputting the floating point data pairs to the multiplier, the input division controller may combine the floating point data into the four floating point data pairs according to the distribution law shown in Equation 1 below to sequentially input the four floating point data pairs to the multiplier and sequentially input an Aa and Bc pair, an Aa and Bd pair, an Ab and Bc pair, and an Ab and Bd pair to the multiplier.

$$A \times B = ( Aa + Ab ) \times ( Bc + Bd ) = Aa \times Bc + Aa \times Bd + Ab \times Bc + Ab \times Bd \qquad ( Equation 1 )$$

When dividing the floating point data input as the operand, the input division controller may divide a size of an M so that a value divided by 2 is the same, and add 1 bit to an M of any one piece of divided floating point data so that the size of the M of the divided floating point data is the same.

When dividing the floating point data input as the operand, in the case of adding 1 bit to the M of any one piece of divided floating point data, the input division controller may input zero (0) to a final bit value of the M of the floating point data.

When dividing the floating point data input as the operand, the input division controller may input actual data before an operand A is divided up to a designated higher bit of the M of the divided first floating point data Aa, input zero to a final bit, input all actual data before being divided to total bits of the M of the second floating point data Ab, input the actual data before being divided up to the designated higher bit of the M of the third floating point data Bc into which an operand B is divided, input zero to the final bit, and divide the floating point data by inputting all the actual data before being divided to total bits of the M of the fourth floating point data Bd.

When dividing the floating point data input as the operand, the input division controller may add a designated implicit bit in front of the M of the floating point data including a lower bit of the M of the floating point data before being divided to allow the multiplier to recognize that it is floating point data including a lower-bit M value among the Ms of the operand before being divided among the divided floating point data.

When dividing the floating point data input as the operand, the input division controller may reflect a size of the higher bit of the M changed when dividing exponent (E) values of second and fourth floating point data Ab and Bd including the lower bit of the M of the floating point data before being divided to adjust an exponent (E′) value of the divided floating point data.

### BRIEF DESCRIPTION OF THE DRAWINGS

FIG. 1 is an exemplary diagram illustrating various floating point data types.

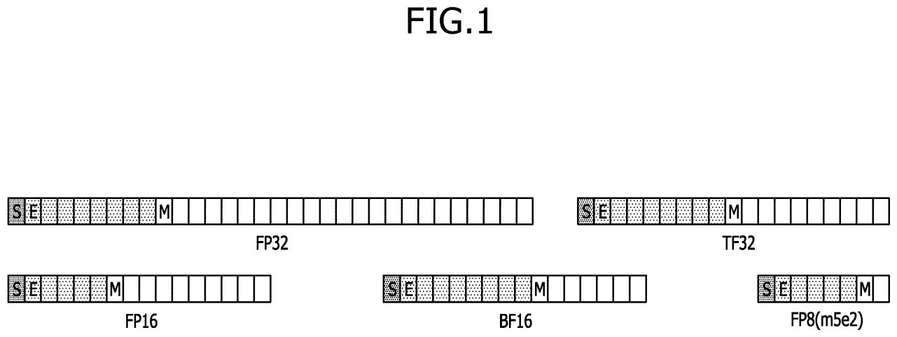

FIG. 2 is an exemplary diagram illustrating a basic floating point unit (FPU) structure that may simultaneously calculate two FP32 (P0, P1), four FP16 (P0 to P3), or eight FP8 (P0 to P7) data in parallel using one FP64 FPU multiplier.

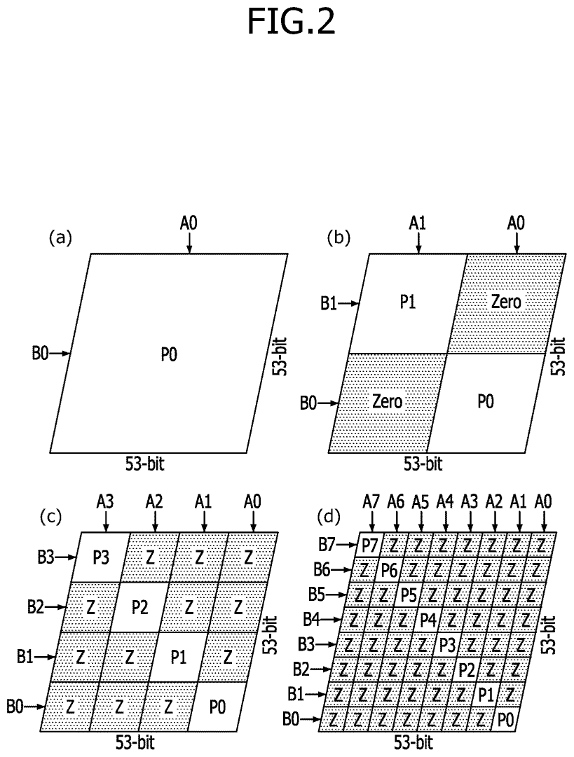

FIG. 3 is an exemplary diagram illustrating operation data types supported by a large artificial neural network accelerator and operation performance for each type in a table form.

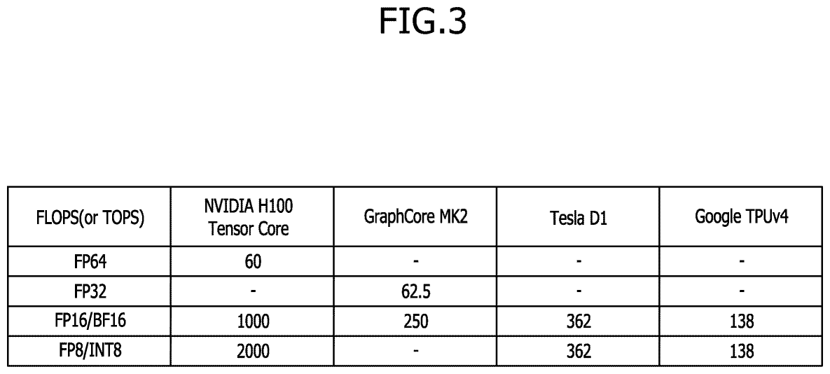

FIG. 4 is an exemplary diagram illustrating a schematic configuration of a MAC apparatus using a floating point unit according to an embodiment of the present invention.

FIG. 5 is an exemplary diagram for describing an operation of an input division controller in FIG. 4.

### DETAILED DESCRIPTION OF EXEMPLARY EMBODIMENTS

Hereinafter, embodiments of a multiply accumulate (MAC) apparatus using a floating point unit and a control method thereof according to the present invention will be described with reference to the attached drawings.

In this process, thicknesses of lines, sizes of components, and the like illustrated in the accompanying drawings may be exaggerated for clearness of explanation and convenience. In addition, terms to be described below are defined in consideration of functions in the present disclosure and may be construed in different ways according to the intention of users or practice. Therefore, these terms should be defined on the basis of the content throughout the present specification.

As described above, in the case of a basic floating point unit (FPU), in order to calculate floating point data of different data types (i.e., large or small data types), there is a problem in that there should be a separate FPU for each data type. However, the related art has improved these problems to not only calculate floating point data of various smaller data types (e.g., FP32, FP16, and FP8) through one FPU that may calculate a large data type (e.g., FP64), but also support a parallel operation for small-sized data types.

However, the related art has a problem in that a maximum size of a data type that may be calculated in hardware in an FPU is limited. In other words, there was a problem that an operation on a data type (i.e., FP32) larger than sizes of data types (e.g., FP16, BF16, FP8, etc.) that may be processed by the FPU implemented in hardware may not be performed.

Accordingly, the present invention provides an apparatus and method for performing an operation on a floating point data type (e.g., FP32) larger than the floating point data type (e.g., FP16 or FP8) implemented to be processed in hardware in the FPU during a MAC operation.

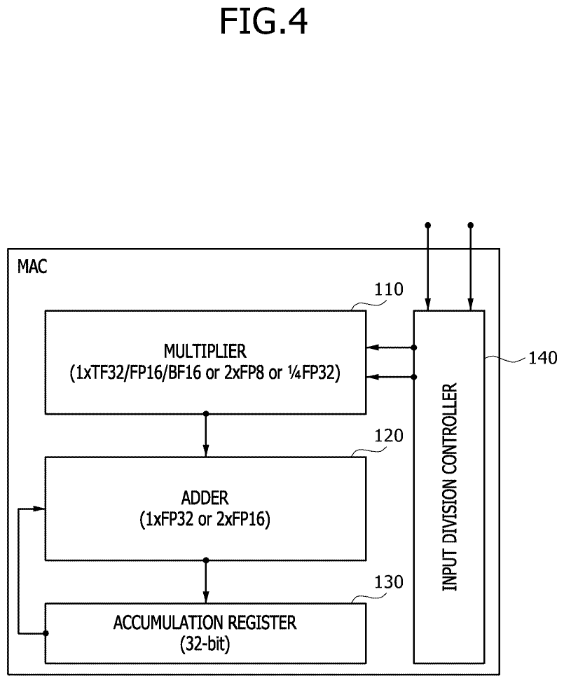

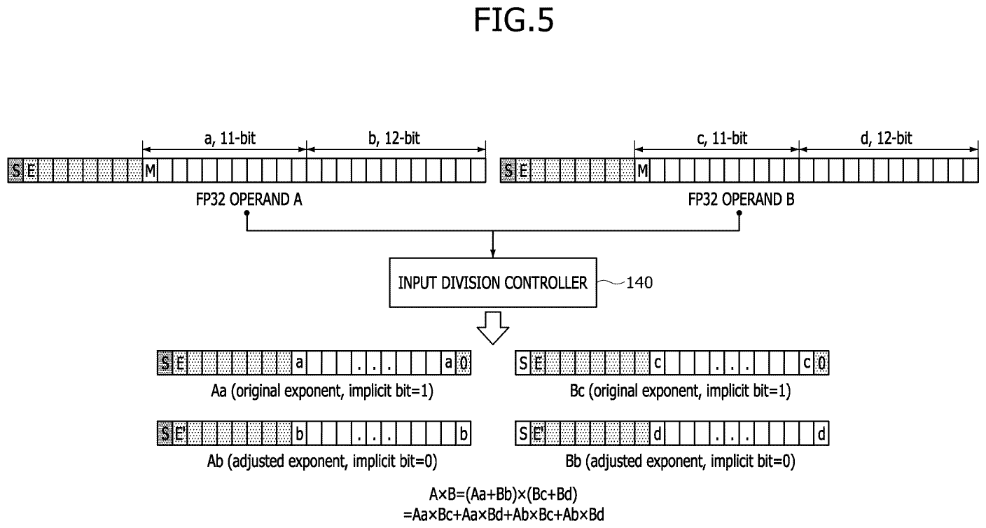

FIG. 4 is an exemplary diagram illustrating a schematic configuration of a MAC apparatus using an FPU according to an embodiment of the present invention, and FIG. 5 is an exemplary diagram for describing an operation of an input division controller 140 in FIG. 4.

As illustrated in FIG. 4, the MAC apparatus using an FPU includes a multiplier 110, an adder 120, an accumulation register 130, and an input division controller 140.

The multiplier 110 performs a multiplication operation on floating point data of less than 32 bits.

For example, the multiplier 110 performs a multiplication operation on one piece of TF32 (19-bit), FP16 (16-bit), or BF16 (16-bit) data, performs a multiplication operation on two pieces of FP8 (8-bit) data, or performs a multiplication operation on ¼ of a piece of FP32 (32-bit) data.

In this case, the ¼ of a piece of FP32 (32-bit) data is divided into TF32 (19-bit) by the input division controller 140 and input to the multiplier 110 (see FIG. 5).

Accordingly, the multiplier 110, which is implemented to perform a multiplication operation on floating point data of less than 32-bit in hardware, sequentially performs a multiplication operation on data, which is only divided into TF32 (19-bit) by the input division controller 140 and input, four times, thereby performing a multiplication operation on FP32 (32-bit) data.

In this case, the ¼ of a piece of FP32 (32-bit) data is divided into TF32 (19-bit) by the input division controller 140 and input to the multiplier 110 (see FIG. 5).

Accordingly, the multiplier 110, which is implemented to perform a multiplication operation on floating point data of less than 32-bit in hardware, sequentially performs a multiplication operation on data, which is only divided into TF32 (19-bit) by the input division controller 140 and input, four times, thereby performing the multiplication operation on FP32 (32-bit) data.

The adder 120 performs an addition operation on the floating point data multiplied by the multiplier 110 and the floating point data accumulated in the accumulation register 130. In this embodiment, the adder 120 is implemented to perform an addition operation on floating point data (i.e., data at least twice as large as the floating point data type to be processed by the multiplier) of up to 32-bit or less.

For example, the adder 120 performs an addition operation on one FT32 (32-bit) or an addition operation on two pieces of FP16 (16-bit) data.

In this embodiment, the accumulation register 130 is implemented to accumulate floating point data (i.e., data such as a floating point data type to be processed by the adder) of less than of up to 32-bit.

The input division controller 140 receives two pieces of FP32 (32-bit) floating point data (i.e., floating point operands), divides each piece of FP32 (32-bit) floating point data into a plurality of pieces of TF32 (19-bit) floating point data of a smaller data type according to a specified method, and then sequentially inputs data to the multiplier 110 a total of 4 times (see FIG. 5).

Referring to FIG. 5, when a plurality of FP32 operands A and B are input to the input division controller 140, the input division controller 140 divides the FP32 operands A and B into a plurality of pieces of floating point data Aa, Ab, Bc, and Bd of each specified form (or a 19-bit data type).

In other words, the FP32 operand A is divided into multiple pieces of floating point data Aa and Ab of a specified type (or the 19-bit data type), and the FP32 operand B is divided into multiple pieces of floating point data Bc and Bd of the specified type (or the 19-bit data type).

In this case, the FP32 operands A and B are each composed of a 1-bit sign (S) value, an 8-bit exponent (E) value, and a 23-bit mantissa (M) value.

The floating point data Aa, Ab, Bc, and Bd are each divided into the form (e.g., the 19-bit data type) specified by the input division controller 140 and composed of a 1-bit S value, a 8-bit E value, and a 12-bit M value.

However, the sizes of the M values of the FP32 operands A and B are 23 bits, but the sizes of the M values of the floating point data Aa, Ab, Bc, and Bd divided by the input division controller 140 are 12 bits, so there is a 1-bit difference from the sizes of the actual data of the FP32 operands A and B.

Accordingly, zero (0) is input to an M value of any one of the plurality of pieces of floating point data Aa and Ab into which the FP32 operand A is divided (e.g., see Aa), and zero (0) is input to an M value of any one of the plurality of pieces of floating point data Ba and Bb into which the operand B is divided (e.g., see Bc).

For example, each of the sizes of the M values of the plurality of pieces of floating point data Aa and Ab into which the FP32 operand A is divided is 12 bits, but the actual data before being divided is input up to the upper 11 bits of the first floating point data Aa, zero is input to the final 12 bits, and all actual data before being divided is input to the total 12 bits of the second floating point data Ab. Similarly, each of the sizes of the M values of the plurality of pieces of floating point data Bc and Bd into which the FP32 operand B is divided is 12-bit, but the actual data before being divided is input up to the upper 11 bits of the third floating point data Bc, zero is input to the final 12 bits, and all the actual data before being divided is input to the total 12 bits of the fourth floating point data Bd.

In this case, when the input division controller 140 divides the FP32 operands A and B, the first and third floating point data Aa and Bc including the upper 12 bits of the M does not need information to enable the multiplier 110 to recognize that they are floating-point data including the upper 12 bits among the divided floating-point data. However, the second and fourth floating point data Ab and Bd that includes the lower 12 bits requires information to enable the multiplier 110 to recognize that it is floating point data including the lower 12 bits (i.e., a lower 12-bit M value among 23-bit M values of the operand before being divided) among the divided floating point data.

In this case, the reason why information is needed to enable the multiplier 110 to recognize that it is floating point data including the lower 12 bits (i.e., the lower 12-bit M value among the 23-bit M values of the operand before being divided) of the divided floating point data is that, for the second and fourth floating point data Ab and Bd, the exponent needs to be adjusted when performing the actual floating point operation because the lower 12-bit M value among the 23-bit M values of the operand before being divided changes to the upper 12-bit M value during division (i.e., there is a difference between the E values of Aa and Bc and the E′ values of Ab and Bd).

Accordingly, this embodiment processes an implicit bit of the floating point operation (e.g., processes an implicit bit as 1 or 0) to determine whether the floating point data input to the multiplier 110 is the floating point data including the upper 12 bits among the divided floating point data or floating point data including the lower 12 bits (i.e., the lower 12-bit M value among the 23-bit M values of the operand before being divided) among the divided floating point data.

For example, the actual value of the floating point data is calculated according to the equation N=(−1)⁵×1.M×2^{E}_{-bias}. In this case, the “1” that is always added in front of the M in the above Equation is the implicit bit, and before performing multiplication and addition on floating point data, it is necessary to add 1 to the highest bit of the mantissa data. However, in this embodiment, among the first to fourth floating point data Aa, Ab, Bc, and Bd divided through the input division controller 140, the implicit bit is included and output only in the first and third floating point data Aa and Bc, which are floating point data including the higher 12 bits among the divided floating point data, and the second and fourth floating point data Ab and Bd, which are the floating point data including the lower 12 bits among the divided floating point data, do not include the implicit bits so that they may be distinguished.

As illustrated in FIG. 5, when the FP32 operands A and B are divided into the plurality of pieces of floating point data Aa, Ab, Bc, and Bd by the input division controller 140, the input division controller 140 combines the plurality of pieces of floating point data Aa, Ab, Bc, and Bd into four pairs according to a distribution law shown in Equation 1 below, and sequentially outputs the corresponding pairs of the floating point data Aa, Ab, Bc, and Bd to the multiplier 110.

$$A \times B = ( Aa + Ab ) \times ( Bc + Bd ) = Aa \times Bc + Aa \times Bd + Ab \times Bc + Ab \times Bd \qquad [ Equation 1 ]$$

That is, the input division controller 140 sequentially outputs an Aa and Bc pair, an Aa and Bd pair, an Ab and Bc pair, and an Ab and Bd pair to the multiplier 110.

Accordingly, the multiplier 110 performs multiplication a total of 4 times using the divided floating point data Aa, Ab, Bc, and Bd for the FP32 operands A and B, thereby performing the multiplication operation on FP32 (32-bit) data.

As already described above, the reason why the FP32 operands A and B are not directly multiplied but divided and processed in this embodiment is that, as illustrated in FIG. 4, the multiplier is implemented in hardware as a small data type that may not directly calculate the FP32 operand. However, according to the present invention, it is possible to perform one operation on the floating point data type (e.g., FP32) larger than the floating point data type (e.g., FP16 or FP8) implemented to be calculated in hardware in the FPU during the MAC operation.

That is, in the case of the MAC operation for TF32/FP16/BF16 supported by the FPU hardware, one operation may be processed with each operation, and FP8 data may process two operations with one operation.

As a result, the present invention has TF32/FP16/BF16 performance of 1, FP8 performance of 2, and FP32 performance of ¼, and there is a technical difference in that the related art may not implement even FP32 performance of ¼. In other words, it is possible to support the operation with the performance of ¼ for data types (e.g., FP16→FP32, FP32→FP64, FP64→FP128, etc.) that are twice as large as the largest data type (e.g., FP32) of the FPU implemented in hardware in the artificial neural network accelerator.

In addition, according to the present invention, it is possible to enable a semiconductor, which includes FPUs for all data types (e.g., FP32, TF32, FP16, BF16, FP8, etc.) to be calculated in a hardware form, to be implemented in a smaller area.

In this case, it is to be noted that the data type described in the MAC apparatus using the FPU according to this embodiment is illustrative and is not intended to be limiting.

According to the present invention, it is possible to process a multiply accumulate (MAC) operation of a data type larger than the data type implemented to be processed in hardware in a floating point unit in an operation environment that requires the MAC operation on data types of various sizes, such as artificial neural network applications.

Although the present invention has been described with reference to embodiments shown in the accompanying drawings, they are only examples. It will be understood by those skilled in the art that various modifications and other equivalent exemplary embodiments are possible from the present invention. Accordingly, a true technical scope of the present invention is to be determined by the spirit of the appended claims. Implementations described herein may be implemented in, for example, a method or process, an apparatus, a software program, a data stream, or a signal. Although discussed only in the context of a single form of implementation (e.g., discussed only as a method), implementations of the discussed features may also be implemented in other forms (e.g., an apparatus or a program). The apparatus may be implemented in suitable hardware, software, and firmware, and the like. A method may be implemented in an apparatus such as a processor, which is generally a computer, a microprocessor, an integrated circuit, a processing device including a programmable logic device, or the like.

What is claimed is:

1. A MAC apparatus using a floating point unit, comprising:
a multiplier that performs a multiplication operation on floating point data;
an adder that performs an addition operation between the floating point data calculated by the multiplier and floating point data accumulated in an accumulation register;
the accumulation register that accumulates the floating point data calculated by the adder; and
an input division controller that, when two pieces of floating point data A and B larger than a calculated data type on which the multiplier performs operation processing are input as operands, divides the two pieces of floating point data A and B into a plurality of pieces of floating point data Aa, Ab, Bc, and Bd according to a specified method and inputs the floating point data Aa, Ab, Bc, and Bd to the multiplier.

2. The MAC apparatus of claim 1, wherein the adder is implemented to perform an addition operation on data at least twice as large as the floating point data type processed by the multiplier.

3. The MAC apparatus of claim 1, wherein the accumulation register is implemented to accumulate floating point data of the same size as the floating point data type processed by the adder.

4. The MAC apparatus of claim 1, wherein, when inputting the plurality of pieces of divided floating point data to a multiplier, the input division controller combines the divided floating point data into four floating point data pairs according to a specified distribution law to sequentially input the corresponding floating point data pairs to the multiplier.

5. The MAC apparatus of claim 4, wherein the input division controller combines the floating point data into the four floating point data pairs according to the distribution law shown in Equation 1 below to sequentially input the four floating point data pairs to the multiplier and sequentially input an Aa and Bc pair, an Aa and Bd pair, an Ab and Bc pair, and an Ab and Bd pair to the multiplier:
$$A \times B = ( Aa + Ab ) \times ( Bc + Bd ) = Aa \times Bc + Aa \times Bd + Ab \times Bc + Ab \times Bd \qquad ( Equation 1 )$$

6. The MAC apparatus of claim 1, wherein, when dividing the floating point data input as the operand, the input division controller divides a size of a mantissa (M) so that a value divided by 2 is the same, and adds 1 bit to M of any one piece of divided floating point data so that the size of the M of the divided floating point data is the same.

7. The MAC apparatus of claim 6, wherein, when 1 bit is added to M of any one piece of divided floating point data, the input division controller inputs zero (0) to a final bit value of the M of the floating point data.

8. The MAC apparatus of claim 6, wherein the input division controller inputs actual data before an operand A is divided up to a designated higher bit of the M of the divided first floating point data Aa, inputs zero to a final bit, inputs all actual data before being divided to total bits of the M of the second floating point data Ab,
inputs the actual data before being divided up to the designated higher bit of the M of the third floating point data Bc into which an operand B is divided, inputs zero to the final bit, and divides the floating point data by inputting all the actual data before being divided to total bits of the M of the fourth floating point data Bd.

9. The MAC apparatus of claim 6, wherein the input division controller adds a designated implicit bit in front of the M of the floating point data including a lower bit of the M of the floating point data before being divided to allow the multiplier to recognize that it is floating point data including a lower-bit M value among the M values of the operand before being divided among the divided floating point data.

10. The MAC apparatus of claim 9, wherein the input division controller reflects a size of the higher bit of the M changed when dividing exponent E values of second and fourth floating point data Ab and Bd including the lower bit of the M of the floating point data before being divided to adjust an exponent E′ value of the divided floating point data.

11. A control method of a MAC apparatus using a floating point unit that includes a multiplier that performs a multiplication operation on floating point data, an adder that performs an addition operation between the floating point data calculated by the multiplier and floating point data accumulated in an accumulation register, and the accumulation register that accumulates the floating point data calculated by the adder, the control method comprising:
when two pieces of floating point data A and B larger than a calculated data type on which the multiplier performs operation processing are input as operands, dividing, by an input division controller, the two pieces of floating point data A and B into a plurality of pieces of floating point data Aa, Ab, Bc, and Bd according to a specified method; and
inputting, by the input division controller, the plurality of pieces of divided floating point data Aa, Ab, Bc, and Bd to the multiplier.

12. The control method of claim 11, wherein the adder is implemented to perform an addition operation on data at least twice as large as the floating point data type processed by the multiplier.

13. The control method of claim 11, wherein the accumulation register is implemented to accumulate floating point data of the same size as the floating point data type processed by the adder.

14. The control method of claim 11, wherein, when inputting the plurality of pieces of divided floating point data to a multiplier, the input division controller combines the divided floating point data into four floating point data pairs according to a specified distribution law to sequentially input the corresponding floating point data pairs to the multiplier.

15. The control method of claim 14, wherein, when sequentially inputting the floating point data pairs to the multiplier, the input division controller combines the floating point data into the four floating point data pairs according to the distribution law shown in Equation 1 below to sequentially input the four floating point data pairs to the multiplier, and sequentially input an Aa and Bc pair, an Aa and Bd pair, an Ab and Bc pair, and an Ab and Bd pair to the multiplier:
$$A \times B = ( Aa + Ab ) \times ( Bc + Bd ) = Aa \times Bc + Aa \times Bd + Ab \times Bc + Ab \times Bd \qquad ( Equation 1 )$$

16. The control method of claim 11, wherein, when dividing the floating point data input as the operand, the input division controller divides a size of M so that a value divided by 2 is the same, and adds 1 bit to M of any one piece of divided floating point data so that the size of the M of the divided floating point data is the same.

17. The control method of claim 16, wherein, when dividing the floating point data input as the operand, in the case of adding 1 bit to M of any one piece of divided floating point data, the input division controller inputs zero (0) to a final bit value of the M of the floating point data.

18. The control method of claim 16, wherein, when dividing the floating point data input as the operand,
the input division controller inputs actual data before an operand A is divided up to a designated higher bit of the M of the divided first floating point data Aa and inputs zero into a final bit, inputs all actual data before being divided to total bits of the M of the second floating point data Ab,
inputs the actual data before being divided up to the designated higher bit of the M of the third floating point data Bc into which an operand B is divided, inputs zero to the final bit, and divides the floating point data by inputting all the actual data before being divided to total bits of the M of the fourth floating point data Bd.

19. The control method of claim 16, wherein, when dividing the floating point data input as the operand, the input division controller adds a designated implicit bit in front of the M of the floating point data including a lower bit of the M of the floating point data before being divided to allow the multiplier to recognize that it is floating point data including a lower-bit M value among the M values of the operand before being divided among the divided floating point data.

20. The control method of claim 19, wherein, when dividing the floating point data input as the operand, the input division controller reflects a size of the higher bit of the M changed when dividing exponent (E) values of second and fourth floating point data Ab and Bd including the lower bit of the M of the floating point data before being divided to adjust an exponent (E′) value of the divided floating point data.
